(19) United States
(12) Patent Application Publication
(10) Pub. No.: US 2015/0143212 A1
(43) Pub. Date: May 21, 2015

(54) METHOD AND SYSTEM FOR OBTAINING CONTENT FROM TEXTS

(71) Applicants: Tomer Shamir, Rehovot (IL); Yaron Azulay, Beit Shemesh (IL)

(72) Inventors: Tomer Shamir, Rehovot (IL); Yaron Azulay, Beit Shemesh (IL)

(21) Appl. No.: 14/517,862

(22) Filed: Oct. 19, 2014

Related U.S. Application Data
(60) Provisional application No. 61/893,242, filed on Oct. 20, 2013.

(51) Int. Cl. G06F 17/22; G06F 17/30; G06F 3/0484

(52) U.S. Cl. CPC G06F 17/2235; G06F 3/04842; G06F 17/30882
USPC 715/205

(57) ABSTRACT

Systems and methods provide content to customers and other users of communication devices, such as mobile devices, including smart phones and other cellular telephones and the like. The content is selected and delivered, or made accessible, to customers by, the system. The content is based on words, word fragments, phrases, and portions thereof, obtained from, texting sessions, for example, Short Message System (SMS) texting sessions and other texting sessions, as well as other text postings on a network, such as a cellular network or the Internet.

### CROSS REFERENCES TO RELATED APPLICATIONS

This patent application is related to and claims priority from commonly owned U.S. Provisional Patent Application Ser. No. 61/893,242, entitled: Method and System for Obtaining Content from Texts, filed on Oct. 20, 2013, the disclosure of which is incorporated by reference in its entirety herein.

### TECHNICAL FIELD

The present disclosed subject matter relates to content delivery over networks.

### BACKGROUND

As smart phone and tablet computer usage continues to grow, text messaging on these devices continues to grow as well. Text messaging is extremely popular, as it is non-intrusive. The recipient is made aware of the text message, but can respond to it when desired.

One form of text messaging is Short Message Service (SMS), where text messages are sent over the cellular telephone networks between senders and receivers of the SMS messages. The number of people using SMS texting on their smart phones continues to grow. Additionally, text messages, including SMS messages, are economical, as they are inexpensive to send.

### SUMMARY OF THE DISCLOSED SUBJECT MATTER

The present disclosed subject matter is related to systems and methods for providing content to customers and other users of communication devices, such as mobile devices, including smart phones and other cellular telephones and the like. The content is selected and delivered, or made accessible, to customers by, the system. The content is based on words, word fragments, phrases, and portions thereof, obtained from, for example, Short Message System (SMS) texting sessions (also referred to as text sessions), and other texting sessions, text postings, such as Tweets, from services such as Twitter® (www.twitter.com), and the like, as well as other text postings on a network, such as a cellular network, the Internet, or other public or wide area network (WAN), or local network.

Embodiments of the disclosed subject matter include a method for providing content to a computerized communication device over a network. The method comprises: monitoring a texting session occurring over the network for words in the texting session matching predetermined words; converting at least one selected matching word to a hyperlink; and, activating a graphic associated with the at least one selected matched word in response to the hyperlink being activated, the activated graphic including an activatable link to a destination over the network from which the content is provided.

Optionally, the method additionally comprises: determining the category of the at least one selected matched word.

Optionally, the at least one selected word is in a first category, and the destination includes a web page associated with the at least one selected word.

Optionally, the at least one selected word is in a second category, the destination includes individual web pages, and the number of the individual web pages is dependent on the number of content providers associated with the at least one selected word.

Optionally, the number of content providers associated with the at least one selected word corresponds to the inventory of content providers associated with the predetermined word matching with at least one selected word.

Optionally, the inventory of content providers is determined based on the number of content providers and their bids associated with the predetermined word.

Optionally, a word is selected from the group consisting of: a single word, multiple words, word fragments, keywords, phrases, identifiers, and combinations thereof.

Optionally, the texting session is in Short Message Service (SMS) format.

Optionally, the network includes a wireless network and the texting session is conducted over local area wireless technology.

Another embodiment of the disclosed subject matter is directed to a system for providing content to a computerized communication device over a network. The system comprises an analysis engine for monitoring a texting session occurring over the network for words in the texting session matching predetermined words; and, a processor in communication with the analysis engine. The processor is programmed to convert at least one selected matching word to a hyperlink; and, activate a graphic associated with the at least one selected matched word in response to the hyperlink being activated, the activated graphic including an activatable link to a destination over the network from which the content is provided.

Optionally, the processor is additionally programmed to determine the category of the at least one selected word, such that the destination includes a web page associated with the at least one selected word.

Optionally, the processor is additionally programmed to determine the category of the at least one selected word, such that the destination includes individual web pages, and the number of the individual web pages is dependent on the number of content providers associated with the at least one selected word.

Optionally, the analysis engine analyses Short Message Service (SMS) text.

Optionally, the analysis engine analyses text transmitted over local area wireless technology.

Other embodiments of the disclosed subject matter are directed to a computer usable non-transitory storage medium having a computer program embodied thereon for causing a suitable programmed system to provide content to a computerized communication device over a network, by performing the following steps when such program is executed on the system. The steps performed comprise: monitoring a texting session occurring over the network for words in the texting session matching predetermined words; converting at least one selected matching word to a hyperlink; and, activating a graphic associated with the at least one selected matched word in response to the hyperlink being activated, the activated graphic including an activatable link to a destination over the network from which the content is provided.

Optionally, the steps additionally comprise: determining the category of the at least one selected matched word, and, 1) when the at least one selected word is in a first category, the destination includes a web page associated with the at least one selected word, and, 2) when the at least one selected word is in a second category, the destination includes individual web pages, the number of the individual web pages dependent on the number of content providers associated with the at least one selected word.

Optionally, the at least one selected word is in the second category, and the number of content providers associated with the at least one selected word corresponds to the inventory of content providers associated with the predetermined word matching with at least one selected word.

Optionally, the inventory of content providers is determined based on the number of content providers and their bids associated with the predetermined word.

Optionally, a word is selected from one of: a single word, multiple words, word fragments, keywords, phrases, identifiers, and combinations thereof.

Optionally, texting session is selected from one of: Short Message Service (SMS) format or in a format supported by local area wireless technology.

This document references terms that are used consistently or interchangeably herein. These terms, including variations thereof, are as follows.

“Smart Phones” are computerized communication devices, including computers, in the form of cellular telephones which combine the cellular telephone operations with a hand held computer (which includes processors, memory, storage media, etc.), which offers Internet (network) access, data storage, e-mail, texting, including SMS texting, applications, and uses operating systems such as ANDROID® or I-Phone® by Apple, Inc. of Cupertino, Calif.

A “banner” is a graphic that appears on the monitor of a user, typically over a web page being viewed. A banner may appear on the web page in forms such as inserts, pop ups, roll ups, scroll ups, pop-behinds, and the like.

A “web site” is a related collection of World Wide Web (WWW) files that includes a beginning file or “web page” called a home page, and typically, additional files or “web pages.” The term “web site” is used collectively to include “web site” and “web page(s).”

A “Uniform Resource Locator (URL)” is the unique address for a file, such as a web site or a web page, that is accessible on the Internet or other public or wide area network.

A “server” is typically a remote computer or remote computer system, machine, or computer program therein, that is accessible over a communications medium or network, such as the Internet, that provides services to other computer programs (and their users), in the same or other computers.

“Advertiser” includes, advertisers, information providers, and other providers of content who are associated with web pages and web sites, and the content thereof, with the web pages and web sites hosted by servers linked to the network, such as the Internet.

“Pay Per Click (PPC),” also known as price per click and cost per click, as used herein, is the amount of money that an advertiser, web site promoter, or other party who owns or is associated with a web site, will pay to a system administrator for providing their advertisement, information, content, listing, link or the like to a user, and the user clicks their mouse or pointing device on the advertisement, information, content, listing, link or the like, such that the user's browser is directed to the targeted web site associated with the advertiser, web site promoter, or other party who owns or is associated with the targeted web site.

A “client” is an application that runs on a computer, workstation or the like and relies on a server to perform some operations, such as sending and receiving templates, text, text messages, graphics, e-mail, and the like.

The term “activation” involves a touch of a hyperlink or other activatable graphic, button, or the like, or a “click” performed by a pointing device, including a mouse, or activatable on-screen cursor, on a location on a computer screen, such as the screen of a smart phone or other communication device or display. The “activation” causes an action of the various software and/or hardware associated with the computer screen (for example, which is touch sensitive), to interact with an activatable link (e.g., an embedded link) to a location on a network (e.g., the Internet), such as an address (URL) of a web page or web site on the network.

“n” and “nth” in the description below and the drawing figures represents the last member of a series or sequence of objects, such as servers, databases, subdatabases, caches, components, data files, etc.

“Short Message Service (SMS)” is a text messaging service component of phone, web, or mobile communication systems, using standardized communications protocols that allow the exchange of short text messages between fixed line or mobile phone devices. Exemplary SMS protocols include Short Message Peer-to-Peer Protocol Specification, Version 5.0 from SMS Forum (www.smsforum.net), 19 Feb. 2003, and J. Peterson, Network Working Group, Request For Comments: 3860, Common Profile for Instant Messaging (CPIM), The Internet Society, August 2004. Both of these documents are incorporated by reference herein.

The terms “linked” and “connected” are used interchangeably herein.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Attention is now directed to the drawings, where like reference numerals or characters indicate corresponding or like components. In the drawings:

FIG. 1A is a diagram of an exemplary system on which embodiments of the disclosed subject matter are performed;

FIG. 1B is a diagram of the application of the application server in accordance with embodiments of the disclosed subject matter;

FIG. 1C is a diagram of an exemplary system on which alternative embodiments of the disclosed subject matter are performed;

FIG. 2A is a diagram of the architecture of the server system on which embodiments of the disclosed subject matter are performed;

FIG. 2B is a database diagram for the BRANDS database of FIG. 2A;

FIG. 2C is a database diagram for the TERMS database of FIG. 2A;

FIG. 2D is a database diagram for the CUSTOMERS database of FIG. 2A;

FIG. 2E is a database diagram for the FOLDERS database of FIG. 2A;

FIG. 3 is flow diagram of a process for the communication devices to acquire the application in accordance with embodiments of the disclosed subject matter,

FIGS. 4A and 4B are flow diagrams of processes for generating content from a texting session in accordance with embodiments of the disclosed subject matter;

FIG. 5A is a screen shot of a communication device of a customer of the disclosed system showing an exemplary SMS texting session, between the customer and another mobile device user;

FIG. 5B is the screen shot of FIG. 5A having been modified with hyperlinks in accordance with embodiments of the disclosed subject matter;

FIGS. 6A-6H are screen shots of the device of the customer of the texting session of FIGS. 5A and 5B, used in explaining the flow diagrams of FIGS. 4A and 4B;

FIG. 7 is a screen shot of an electronic graphic on a customer's communication device in accordance with an embodiment of the disclosed subject matter;

FIG. 8 is a screen shot of a home page from a browser redirection, in accordance with an embodiment of the disclosed subject matter;

FIG. 9A is a screen shot of an e-mail in box on the communication device of a customer of the system of the disclosed subject matter;

FIG. 9B is a screen shot of a home page from a browser redirection, in accordance with the e-mail embodiment of the FIG. 9A;

FIG. 10A is a screen shot of an e-mail in box on the communication device of a customer of the system of the disclosed subject matter;

FIG. 10B is a screen shot of a web page in accordance with the e-mail embodiment of the FIG. 10A;

FIG. 10C is a screen shot of a web page in accordance with the e-mail embodiment of FIG. 10A; and,

FIG. 11 is a screen shot of a text message on the communication device of a customer of the system of the disclosed subject matter.

### DETAILED DESCRIPTION OF THE DRAWINGS

Throughout this document, numerous textual and graphical references are made to trademarks. These trademarks are the property of their respective owners, and are referenced only for explanation purposes herein.

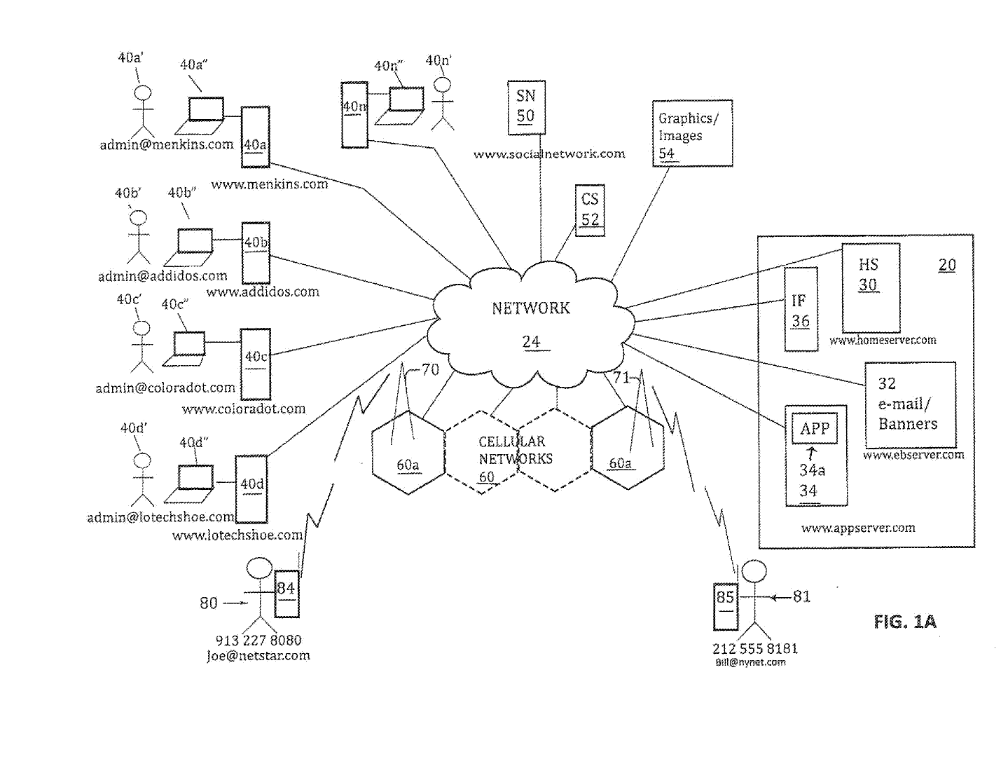

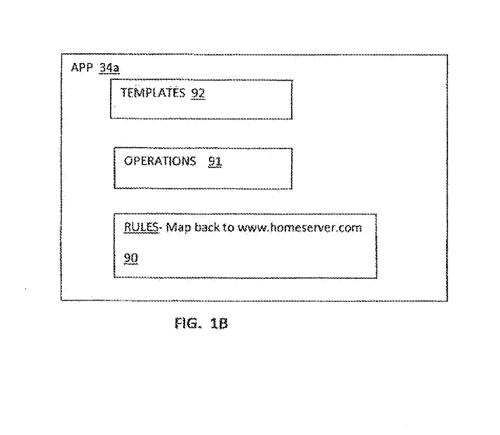

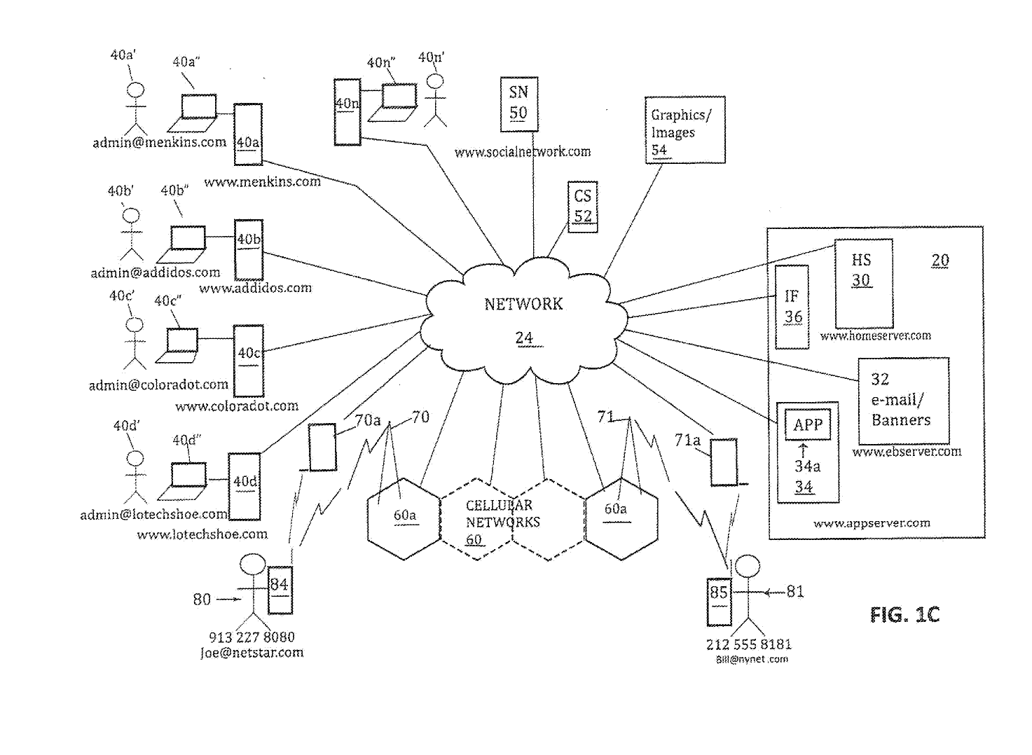

FIG. 1A shows the present disclosed subject matter in an exemplary environment. The present disclosed subject matter employs a system 20, which is a computer system. The system 20 is formed of various computers, including servers and server components, that are linked to a communications network, such as a wide area network (WAN), or public network, that may be, for example, the Internet 24.

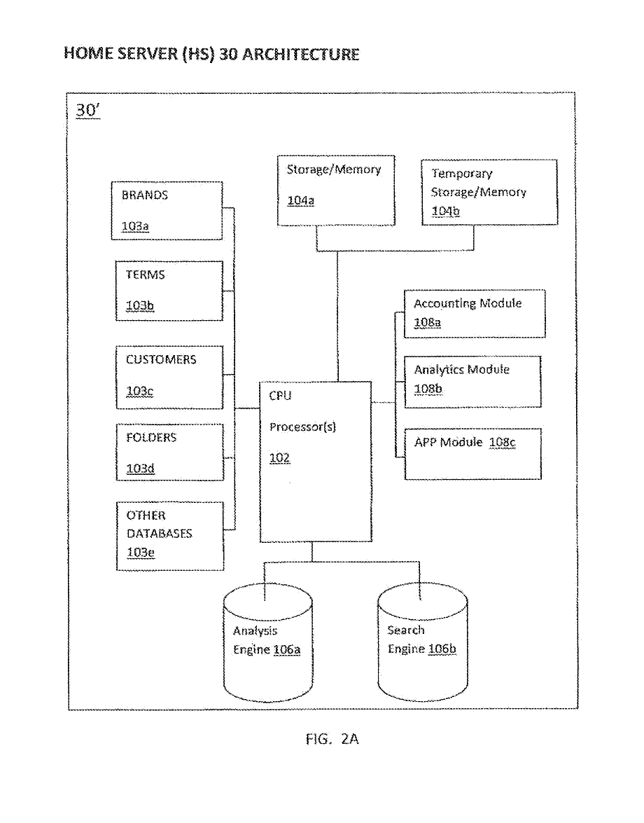

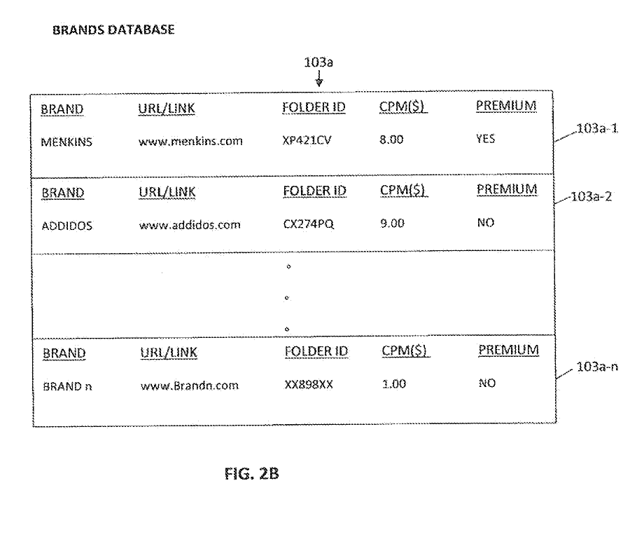

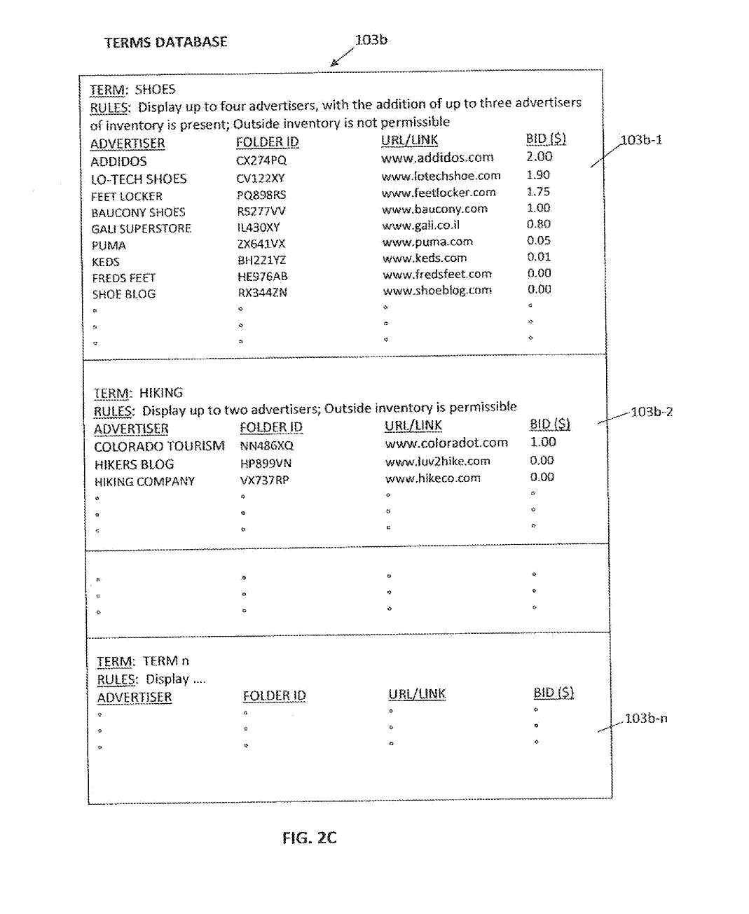

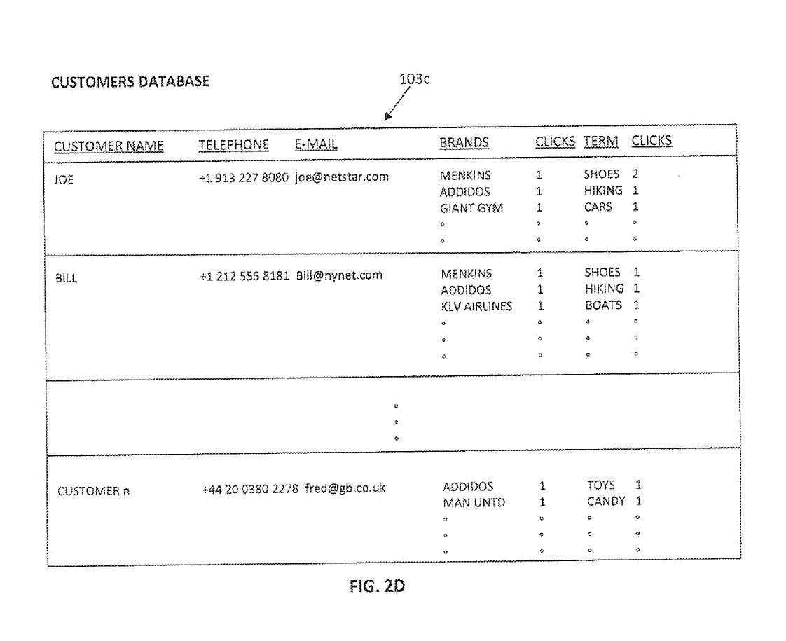

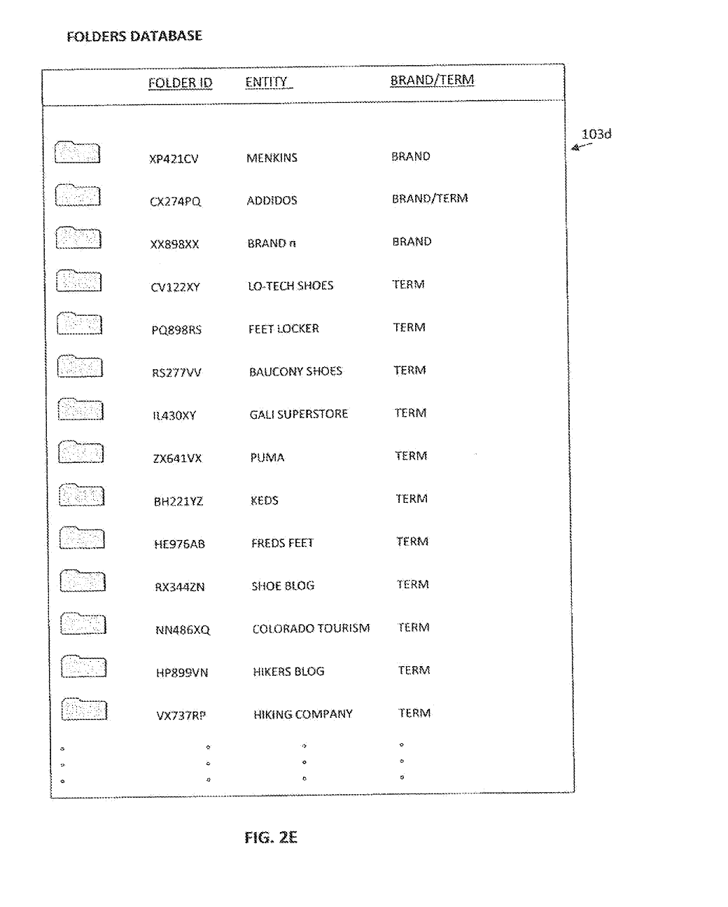

There are, for example, numerous servers that form the system 20. These servers, for example, include a home server (HS) 30 (the home server 30 including a system 30′, shown in FIG. 2A), an e-mail/banners server 32, an application server 34 (which stores, maintains, and serves the application (APP) 34a, shown in FIG. 1B), and can include other servers to perform other supporting functions. The servers 30, 32, 34 are electronically linked, including data linked (hereinafter “electronically linked”), both inside and outside of the system 20. If linked outside the system the servers 30, 32, 34 are in electronic and data communication with each other, being linked to each other via the Internet 24. The servers 30, 32, 34 include processors and other computer components for performing the requisite functions as detailed below, and the components may be based in hardware, software, or combinations thereof.

While a single server is shown for each of the servers 30, 32, 34, these servers may be single or multiple servers. These single or multiple servers include internal memory, storage media, processors, microprocessors and databases for performing the functions of the disclosed subject matter, and/or be associated with external memory, storage media, processors, microprocessors and databases.

There is also an interface (IF) 36 in the system 20, which is accessible by users, such as system administrators. The interface is linked to the home server 30, e-mail/banners server 32 and the application server 34. The interface 36 allows the aforementioned users, to interact with, including program, the servers 30, 32, 34 of the system 20, as well as all components related thereto, from either local connections to the system 20 or remotely from the system 20, via the network 24.

The servers 30, 32, 34 of the system 20 are linked (either directly or indirectly) to an endless number of other servers and the like, via the Internet 24. These other servers, for example, servers 40a-40n, 50, 52, 54, are also linked to the Internet 24, and each other, either directly or indirectly. The aforementioned servers 30, 32, 34, 40a-40n, 50, 52, 54 are exemplary for describing the operation of the system 20.

These other servers, typically outside of the system 20 as shown, include third party servers 40a-40n, associated with Content providers, for example, for words, Brands and Terms, associated with the system 20, and the corresponding administrators 40a′-40n′ and their computers 40a″-40n″ (associated with URLs, for example, the system administrator 40c′(computer 40c″) of server 40c for “Colorado Tourism”, with the URL www.coloradot.com, has the e-mail address admin@coloradot.com, the same holds true for the other exemplary servers 40a, 40b and 40d). These servers 40a-40n are used for administering and providing content to system 20 customers, e.g., Joe 80, and Bill 81, in association with the home server 30.

There are also social network servers, represented for example by the server (SN) 50 with the URL www.socialnetwork.com, which link to the system 20 and allow for registration of customers on the system 20. There is also a content server (CS) 52, representative of servers where the system 20 (home server 30 and system 30′ therein) obtains outside or non-system inventory for advertisers associated with terms in the TERMS database 103b of the system 30′. There is also a graphics/imaging server 54, representative of servers which provide for placing graphics in the requisite templates from the application (APP) 34a, from the folders, of the folders database 103d. There are also servers (not shown) which may be associated with the system 20, as well as associated with the cellular networks 60. The cellular networks 60 are linked to the Internet 24.

The cellular networks 60, represented by cells 60a, include towers, for example, towers 70, 71, which are shown sending and receiving signals from the respective customers 80 (Joe), 81 (Bill), through their respective communication devices 84, 85. The cellular networks 60 support SMS and its associated protocols. These communication devices 84, 85, are, for example, smart phones (client computers or clients). For example, the customer 80 (Joe) of the smart phone 84 has the United States telephone number 913.227.8080 (area code-three digits followed by the seven digit telephone number) and the e-mail joe@netstar.com, which is linked to the smart phone 84. Similarly, for example, the customer 81 of the smart phone 85 has the United States telephone number 212.555.8181 and the e-mail bill@nynet.com, which is linked to the smart phone 85.

Alternatively, the sending and receiving of signals for the texting sessions to/from the customers 80, 81, as detailed herein, are also facilitated over wireless networks, for example, local area wireless technology, such as WIFI®, or the Institute of Electrical and Electronics Engineers (IEEE) standard 802.11 (for example, this IEEE standard 802.11 as detailed in IEEE Std. 802.11n-2009, IEEE Standard for Information Technology-Telecommunications and information exchange between systems-Local and metropolitan area networks-Specific Requirements, Part 11: Wireless LAN Medium Access Control (MAC) and Physical Layer (PHY) Specifications, Amendment 5: Enhancements for Higher Throughput, from IEEE Computer Society, 29 Oct. 2009, this document incorporated by reference herein). As shown in FIG. 1C, the customers 80, 81 access the network, i.e., the Internet 24, through wireless network servers 70a, 71a, for their texting sessions, in accordance with the texting sessions detailed herein, on which the systems and methods disclosed herein, operate. Otherwise, FIG. 1C is similar to FIG. 1A in all operational aspects, with the same or similar components in accordance with the numbering in FIG. 1A, and as detailed above for FIG. 1A.

While various servers have been listed, this is exemplary only, as the present disclosed subject matter can be performed on an endless numbers of servers and associated components, that are in some way linked (directly or indirectly) to a network, such as the Internet 24. Additionally, all of the aforementioned servers include components for accommodating various server functions, in hardware, software, or combinations thereof, and typically include storage media, either therein or associated therewith. Also in this document, the aforementioned servers, storage media, and components can be linked to each other or to a network, such as the Internet 24, either directly or indirectly.

The home server (HS) 30, also known as a main server, is of an architecture for a system 30′ (FIG. 2A), which includes one or more components, modules, other computerized devices, and the like, for providing numerous additional server functions and operations. The home server 30, for example, functions in configuring, executing, sending and receiving electronic communications such as e-mail, texts, impressions, and the like, analyzing SMS and other texts for terms, keywords, phrases and combinations thereof, and administering, selecting and providing content to customers based on the analysis of the SMS texts and other texts (e.g., those transmitted over wireless networks, including portions of the Internet), providing accounting functions (accounting module 108a in FIG. 2A), such as administer pay per click advertising, debit and credit advertisers' or information providers' (collectively referred to hereinafter as “advertisers”) accounts, administering and managing the various databases 103a-103n, comparison and matching functions, policy and/or rules processing, various search and other operational engines, browser directing and redirecting functions, and the like. While a single home server (HS) 30 is shown, the home server 30 may be formed of multiple servers and/or components.

The home server 30 may also be configured to provide content, for example, time relevant content, such as in the form of dynamic e-mail, for example as disclosed in U.S. patent application Ser. No. 10/915,975 (U.S. Patent Application Publication No. US 2005/0038861 A1), entitled: Method And System For Dynamically Generating Electronic Communications, and U.S. patent application Ser. No. 11/774,106 (U.S. Patent Application Publication No. US 2008/0098075 A1), entitled: Method And System For Providing Electronic Communications With Dynamically Provided Content To Third Party Mail Transfer Agents, the disclosures of which are incorporated by reference herein. The home server 30 is also configured to send text messages, including SMS messages to communication devices of customers, for example, the communication devices (smart phones) 84, 85, of customers Joe 80, and Bill 81, respectively.

The home server (HS) 30 includes various processors, including those in a central processing unit (CPU) 102 (FIG. 2A), and including microprocessors, as part of the system 30′, for performing the server functions and operations detailed herein, and storage media 104a, 104b, either internal or associated therewith. The system 30′ of the home server 30 is shown in FIG. 2A, to which attention is also directed, the storage media include databases, for example, for BRANDS 103a, TERMS 103b, CUSTOMERS 103c, FOLDERS 103d, and database 103e, representative of other databases useful in the operation of the home server 30 and the system 20.

There is also memory and storage, represented by storage/memory unit 104a and temporary storage/memory 104b. Storage unit 104b, for example, stores machine executable instructions associated with the operation of the components of the home server 30 (and system 30′), including modules, engines, processors, and the like.

While the aforementioned databases and storage/memory are shown, this is for explanation purposes, as the home server 30 may be associated with additional caches, databases, as well as numerous other additional storage media, both internal and external thereto. For explanation purposes, the home server 30 may have a uniform resource locator (URL) of, for example, www.homeserver.com.

This home server 30 employs an analysis engine 106a, which analyzes SMS text and coordinates the content for the customer based on the databases 103a-103n. The analysis engine 106a may also link to the search engine 106b or a search engine in another server or the like via the Internet 24, in order to perform the operations disclosed herein. The analysis engine 106a, for example, functions to analyze and select and/or obtain words from texting sessions, and perform comparison, matching and equivalence functions for words, with Brands and Terms in the respective databases 103a, 103b. While the aforementioned engines are shown, this is for explanation purposes, as the home server 30 and the system 30′ embodied therein, may be associated with additional engines, both internal and external thereto.

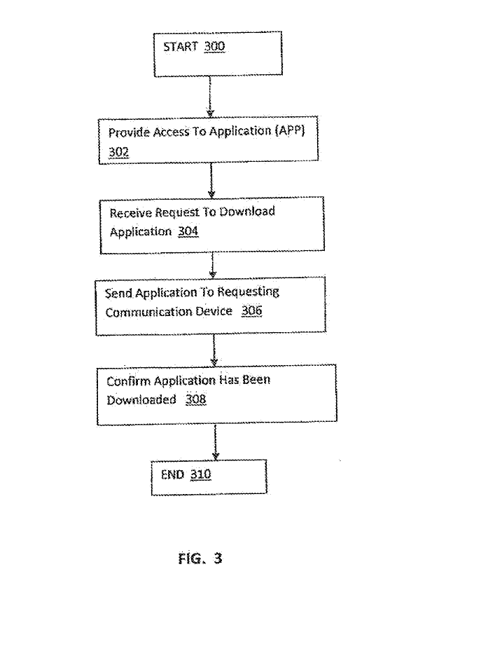

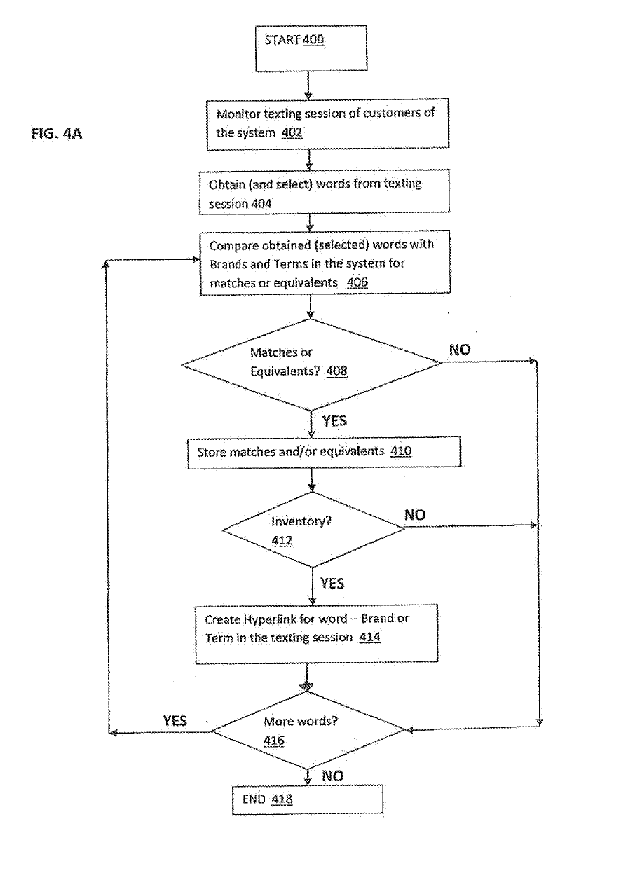

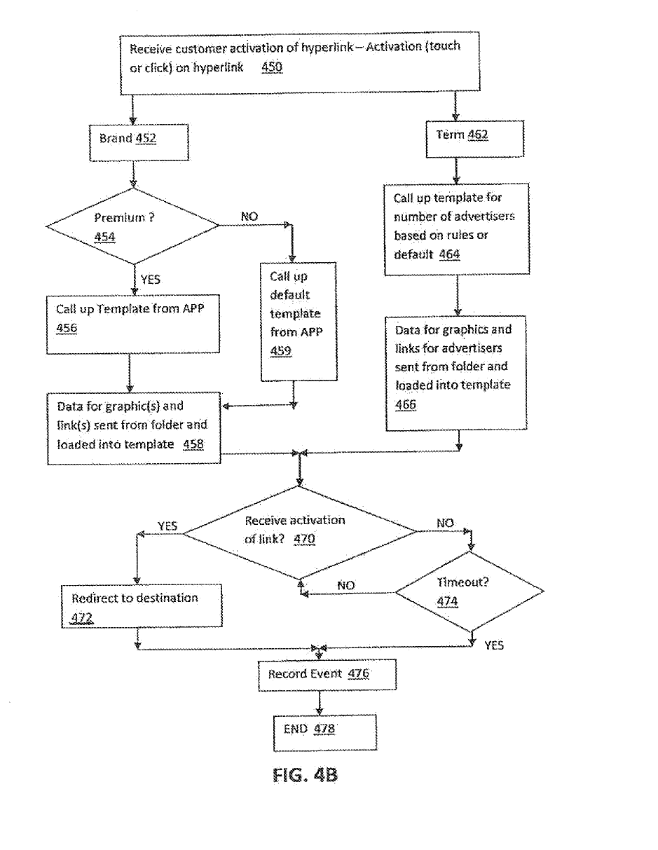

The home server 30 (and its system 30′) also includes an accounting module 108a, for handling BRAND and TERM advertiser and information provider (collectively referred to hereinafter as “advertiser”) accounts. There is also an analytics module 108b, which performs various analytics based on inventory associated with the brands and terms, presented to customers, and clicks on the various graphics associated with each advertiser, as well as conversions, timeouts and the like. There is also an application module (APP Module) 108c, for coordinating the application 34a with the downloaded and activated applications from the communication devices. e.g., devices 84, 85 of the customers 80, 81, and is applicable with the processes of FIGS. 3, 4A and 4B. This coordination includes, for example, administering the application 34a mapping back to the home server 30 and the system thereof 30′, and, the placement of graphics/images and/or activatable links into the templates of the application 34a (as per the process of FIG. 4B). While the aforementioned modules are shown, this is for explanation purposes, as the home server (HS) 30 may be associated with additional modules, both internal and external thereto.

The aforementioned databases 103a-103e, storage/memory 104a, 104b, engines 106a, 106b, and modules 108a-108c, are all interconnected to each other, either directly or indirectly. They are also linked, either directly or indirectly, to the CPU 102.

FIG. 2B shows the BRANDS database 103a, formed of subdatabases 103a-1 to 103a-n. Each subdatabase 103a-1 to 103a-n is for a single brand, including a single advertiser, the advertiser's content also known as inventory. Subdatabase 103a-1 is exemplary of all of the subdatabases 103a-2 to 103a-n. Subdatabase 103a-1 is for the advertiser Menkin's Department Store. Their brand is MENKINS, with a URL or link to which customers will be directed, www.menkins.com, a folder XP421CV, in the folders database 103d, in which Menkins graphics for templates are stored, a cost for 1000 graphics or impressions being shown to customers on their devices ($8.00), and an indication if Menkins Department Store is a premium advertiser. Subdatabase 103a-2 is for the brand ADDIDOS shoes, and is in accordance with the organization detailed above for database 103a-1.

FIG. 2C shows the TERMS database 103b, formed of subdatabases 103b-1 (Term=SHOES), 103b-2 (Term=HIKING) to 103b-n (Term=TERM n). Each subdatabase lists the specific term and the inventory, advertisers, for the term. For example, the TERM subdatabase 103b-1 is for the term SHOES and the inventory includes advertisers ranked from highest bid to lowest bid, ADDIDOS (also a BRAND advertiser) to SHOE BLOG.

FIG. 2D shows the CUSTOMERS database 103c, with subdatabases 103c-1 to 103c-n. Each subdatabase 103c-1 to 103c-n includes customer information as well as indications of customer behavior, advertisers the customers have been exposed to, and activations (e.g., the number of activations) associated with each advertiser.

FIG. 2E shows the FOLDERS database 103d, which includes folders, which contain the graphics/images, e.g., representative data therefore, for each advertiser. The graphics from each folder are rendered into each template, or location in the template, for the advertiser, when the application 34a is activated, as detailed below. The graphics from the respective folders may be rendered into the template, or locations thereof, by the graphics/imaging server 54, which converts the aforementioned representative data for the graphics/images, into the actual graphics/images. Another exemplary graphics/imaging server permissible as the server 54 includes the imaging server disclosed in U.S. patent application Ser. No. 10/915,975 (U.S. Patent Application Publication No. US 2005/0038861 A1), entitled: Method And System For Dynamically Generating Electronic Communications.

The E-mail/banners server 32 may include one or more components, modules or the like, and may be one or more servers, but is shown for description purposes as a single server. The e-mail/banners server 32 is of architecture for creating, processing and sending e-mails, obtaining and assembling content for e-mails. The e-mail/banners server 32 is configurable to work with numerous types of e-mail clients, associated with various intended recipients (users), such as America Online® (AOL®), Eudora®, Outlook®, G-Mail®, Yahoo® Mail, and other web-based clients.

The e-mail/banners server 32 is also configured to handle banners and other impressions similar to that for e-mail. The e-mail/banners server 32 includes various processors, including microprocessors, for performing the aforementioned server functions and operations and storage media, either internal or associated therewith. Other databases, as well as numerous other additional storage media, both internal and external thereto, for numerous functions may also be part of the e-mail/banners server 32. For explanation purposes, the e-mail/banners server 32 has a uniform resource locator (URL) of, for example, www.ebserver.com.

The e-mail/banners server 32 includes various processors, including those in a central processing unit (CPU), and including microprocessors, for performing the server functions and operations detailed herein, such as assembling and sending electronic communications such as e-mails, banners and the like, and storage media, either internal or associated therewith. While a single e-mail/banners server 32 is shown, the e-mail/banners server 32 may be formed of multiple servers and/or components.

The application server 34 is, for example, a server which stores and delivers applications device over the network, for example, the Internet 24 and the cellular networks 60. The application server 34 stores the application or application software (APP) 34a, shown in FIG. 1B, to which attention is also directed.

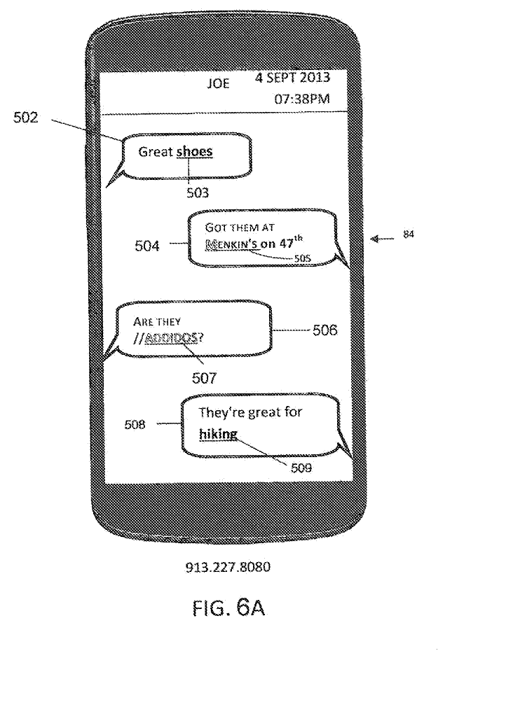

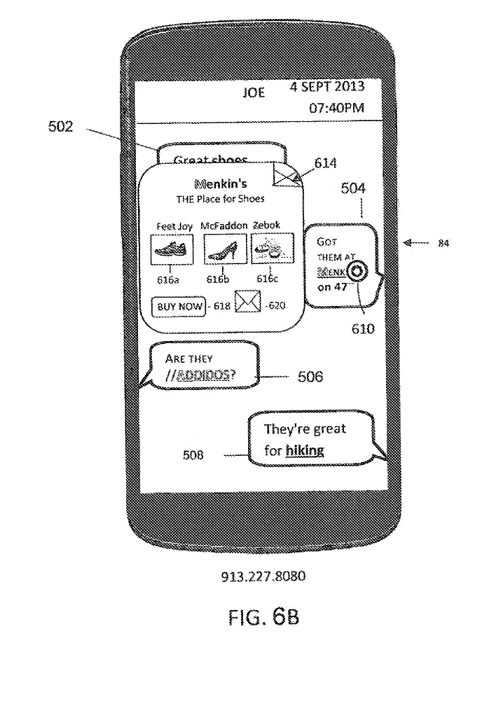

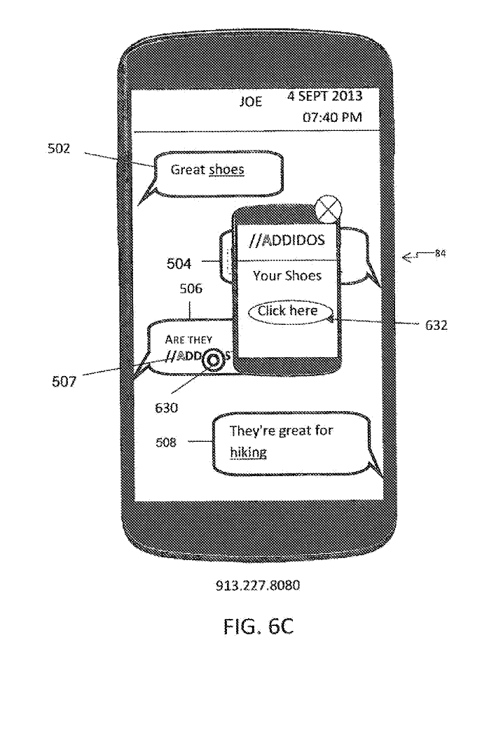

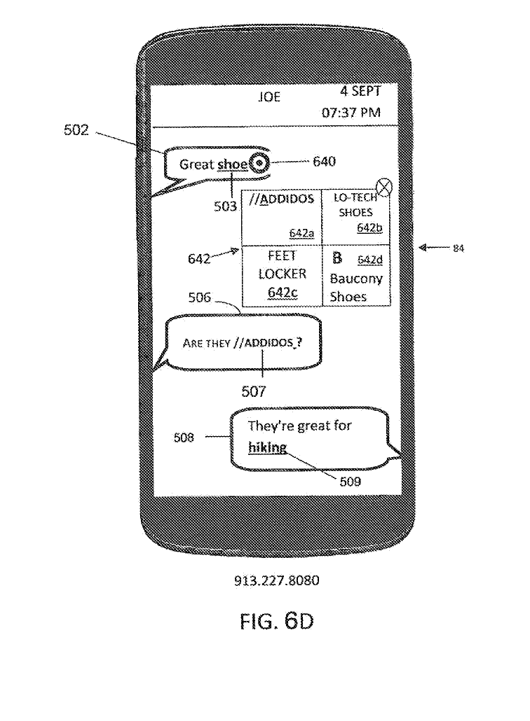

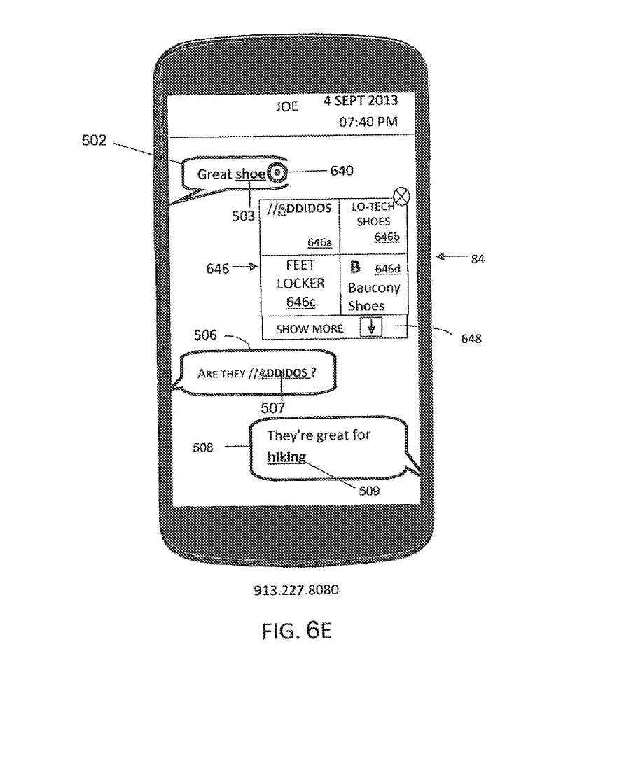

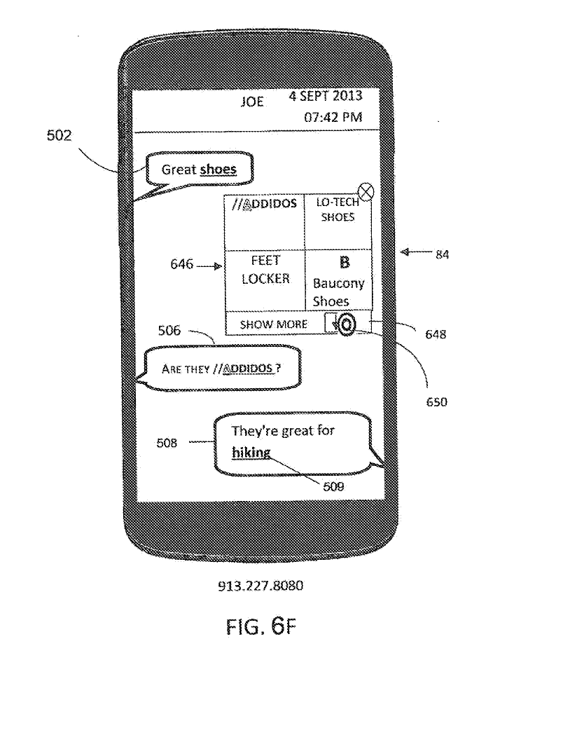

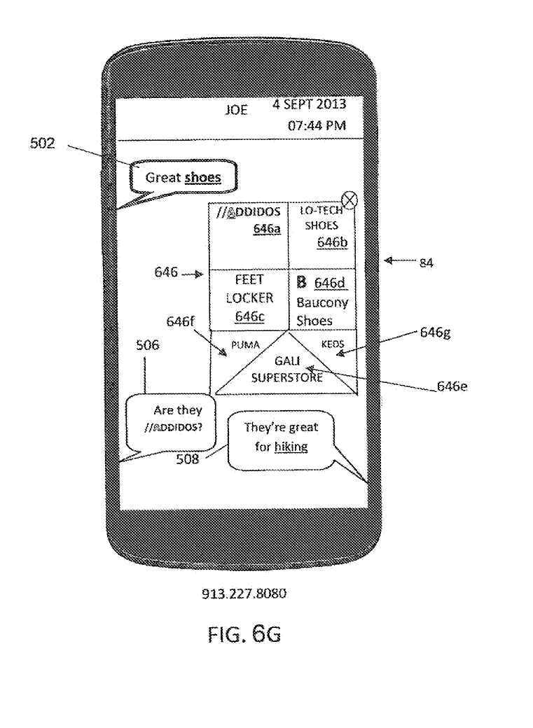

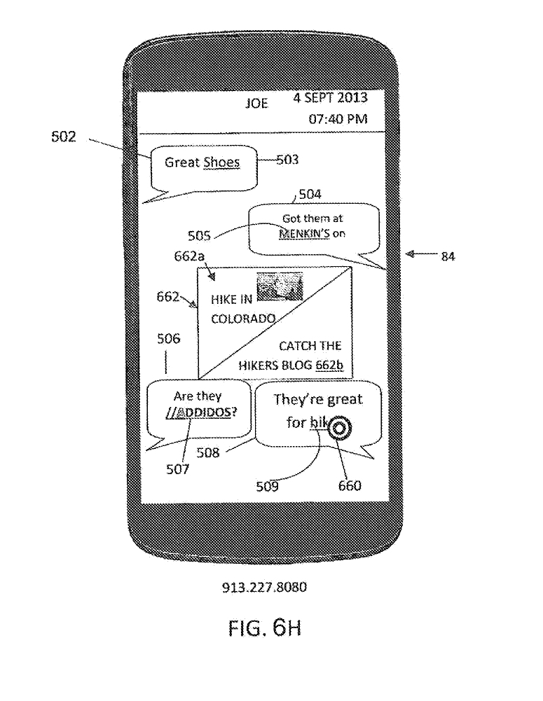

The application 34a, when installed on a communication device, maps back to the system 20 (in accordance with rules 90), such as to the home server 30. The application or application software (operations 91) also causes the communication devices 84, 85 (or other computer running the application), to perform tasks, including accessing the system 20 (system 30′ of the home server 30), such that SMS texts are analyzed and content is delivered to the senders and or receivers on the SMS text in accordance with the SMS text, by the system 20. The application 34a also includes templates 92, which are filled with graphics (e.g., data representative of the templates, which is convertible into the supporting template graphics upon activation of graphics rendering process for the hyperlinks, detailed below for FIGS. 4A and 4B) for the advertisers associated with the BRANDS and TERMS of the system 20 (stored in the folders of FOLDERS database 103d). The templates, for example, facilitate multiple popups, displays, and the like, which are associated with a graphic and activatable (for example, by an activation such as a touch or a “click”) hyperlink, as detailed below and shown graphically in FIGS. 6A-6H.

The application server 34 includes various processors, including those in a central processing unit (CPU), and including microprocessors, for performing the server functions and operations detailed herein, and storage media, either internal or associated therewith. While a single application server 34 is shown, the application server 34 may be formed of multiple servers and/or components. The application server 34 is accessible over the network 24 by its URL, www.appserver.com.

Turning also to FIGS. 3, 4A and 4B, exemplary implementations of computer implemented processes, including processes and/or subprocesses therein, performed by the computers, machines, processors, servers and other computerized components of the system 20, in accordance with embodiments of the disclosed subject matter, will now be described. FIG. 3 is flow diagram of the application and its being acquired by the requisite communication devices, while FIGS. 4A and 4B are processes (methods), for providing content to the requisite communication device, and/or e-mail address based on the SMS texting or text session (“texting session” and “text session” used interchangeably herein). The aforementioned processes, including processes and/or subprocesses therein, are, for example, performed automatically and in real time.

In FIG. 3, at block 300, the process for the application starts. At block 302, the application server 34 allows communications devices, such as smart phones 84, 85, to access the application and receive requests to down load the application (APP) 34a from the application server 34, at block 304. The requester accesses the application 34a by accessing the application server 34, for example by directing their browsing application to www.appserver.com. The application server 34 then sends, e.g., pushes, the application 34a to the requesting communication device 84, 85, at block 306. The application server 34 receives confirmation that the communication device 84, 85 has successfully received the downloaded application 34a, at block 308. This process repeats absent a confirmation, and with the confirmation ends at block 310.

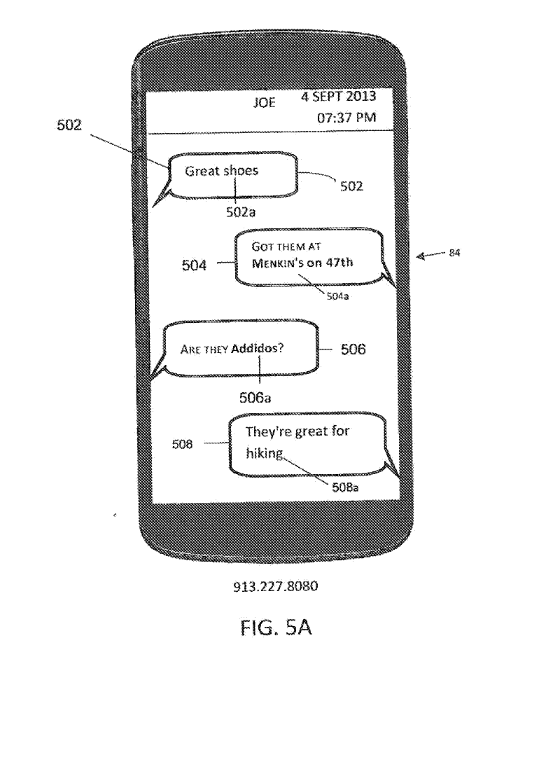

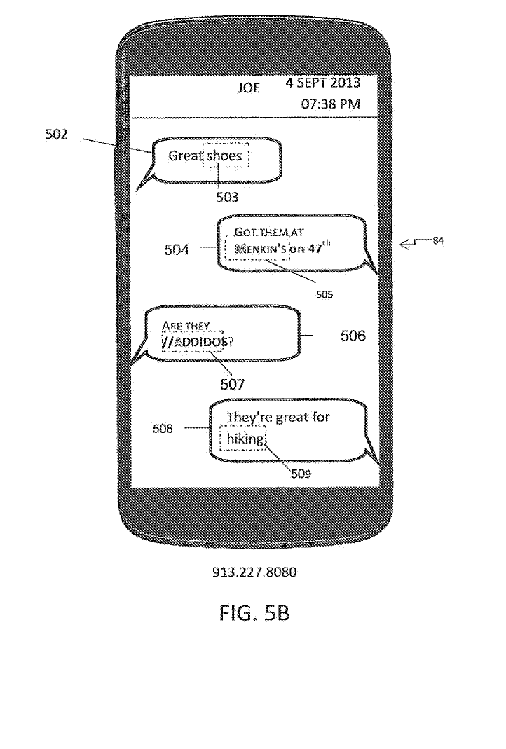

The process of FIG. 4A starts at block 400, as the communications devices 84, 85, have-activated the application 34a (which was downloaded thereto from the application server 34), and a texting session, SMS texting session, begins. The texting session is mapped back to the system 30′ of the home server 30. An example texting session which will be described herewith is shown in FIGS. 5A, the initial texting session, and FIG. 5B, the texting session in accordance with the process of FIG. 4A, to which attention is also directed. The process is, for example, performed automatically, but may be performed manually where indicated. The process is, for example, performed in real time.

At block 402, the SMS texting session is monitored, for example, by the system 30′ in the home server 30, including by the analysis engine 106a. The initial texting session is shown in FIG. 5A. Due to the speed of the process of FIG. 4A, the texting session actually seen by the customers, such as customer Joe 80 with his smart phone 84, appears almost instantly upon the texting session being created. This resultant texting session is shown, for example in FIG. 5B.

Words, word fragments, keywords, phrases, identifiers and the like (collectively “words”) are obtained, for example, by being selected from the text blocks 502 (“Great shoes”), 504 (“Got them at Menkins on 47^{th}”), 506 (“Are they Addidos?”) and 508 (“They're great for hiking”), of the texting session (of FIG. 5A), at block 404. The words are obtained, for example, in accordance with rules and policies either stored or programmed into the storage 104a, 104b of the system 30′ (programmed into the system 30′ of the home server 30 by a system administrator through the interface 36). For example, the obtained or selected words from the exemplary texting session shown in FIG. 5A, are “shoes” 502a, “Menkins” 504a, “Addidos” 506a and “hiking” 508a. The obtained words are typically placed into temporary storage, such as temporary storage 104b.

Each word, for example, “shoes,” “Menkins,” “Addidos,” and “hiking”, is compared with the Brands and Terms stored in the respective databases 103a (BRANDS), 103b (TERMS), at block 406, for example. It is determined if there is a match or equivalent between the word and the stored brand or term in the databases 103a, 103b, at block 408.

For example, the word “Menkins” 504a has been obtained from the texting session in box 504. When compared with the system databases 103a, 103b, there is a match with the brand MENKINS, in the Brands database 103a.

While the match above is an exact match, the word “Menkins” with the brand “Menkins” of the brands database 103a, the matches need not be exact matches, and may be equivalents, which are also acceptable. For example, the equivalents may be based on rules and policies, for example, a word similar in spelling or subject matter. For example, words such as “Menkin's Store”, a phrase using the word “Menkins”, or “Mankin's”, misspelling and the apostrophe, will be equated to the stored brand “Menkins” in the Brands database 103a. This equivalence of words with brands is also applicable to words and terms, the terms in the Terms database 103b.

If there is not a match or equivalent for the word, with a brand or term of the databases 103a, 103b of the system 30′, the process moves to block 416, which is detailed below.

The matched or equivalent word, corresponding to a Brand or Term of the system 30′, is now optionally stored at block 410. The storage may be in the temporary storage 104b.

For each matched or equivalent word, the process moves to block 412, either from block 408 or block 410. The aforementioned processes or portions thereof, of blocks 404, 406, 408, 410 and 412, are performed by components of the system 30′, including, for example, the analysis engine 106a and/or the CPU 102.

At block 412, for each matched or equivalent word, with a brand or term, it is determined if there is inventory, advertisers in the respective Brands 103a or Terms 103b database. The amount of inventory necessary for there to be inventory is in accordance with rules and policies, but the amount needed is typically at least one advertiser. While there is typically inventory for a Brand, the system 30′ (analysis engine 106a) makes this check as a matter of redundancy. Each term in its term subdatabase 103b-1 to 103b-n is checked for inventory. While internal inventory, from the databases 103a, 103b is preferred, inventory may also be obtained from outside of the system 30′, such as from the content server (CS) 52 (FIG. 1A), and/or via the search engine 106b.

For example, the term “shoes” has inventory, as seen in subdatabase 103b-1, “Addidos” through “Shoe Blog”. The brand “Menkins” has inventory, as shown in subdatabase 103a-1. Similarly, “Addidos” as a brand has inventory, as shown in subdatabase 103a-2. The term “hiking” has inventory, “Colorado Tourism” through “Hiking Company”, as shown in subdatabase 103b-2.

If inventory is not present for the Brand or Term corresponding to the matched or equivalent word, the process moves to block 416, as detailed below.

With inventory present for the requisite brand or term, the process moves to block 414, where hyperlinks are placed for the word, of the brand or term, in the texting session. The process moves to block 416.

At block 416, it is determined if there are any more obtained (selected) words to be processed. If more words are to be processed, the process returns to block 406. If all words have been processed for the testing session, the process moves to block 418, where it ends.

The process ends, at block 418, with hyperlinks for the term “shoes” (broken line box 503), for the brand “Menkins” (broken line box 505), for the brand “Addidios” (broken line box 507), and for the term “hiking” (broken line box 509), as shown in FIG. 5B. For the brands “Menkins” and “Addidos”, the hyperlinks (broken line boxes 505 and 507, respectively) are graphical, in that they are more than words in block letters. The graphics for these two hyperlinks are in the folders of the FOLDERS database of FIG. 2E. The graphics for the “Menkins” hyperlink is identified by matching the Folder Identification (ID) in the Brands database 103a (FIG. 2B) with the ID for the corresponding folder in the Folders Database 103d (FIG. 2E), “Menkins” having the Folder ID “XP421CV”, and “Addidos” having the Folder ID “CX274PQ”, in the respective databases 103a (BRANDS), 103d (FOLDERS).

While the process has been shown for a texting session of a plurality of text blocks, the process can alternately be performed for individual words of text, word fragments of text, text blocks, and combinations thereof, as they are created.

Attention is now directed to FIG. 4B, a diagram of the process of obtaining content, once the hyperlinks are placed in the text of the texting session, as shown in FIG. 6A, in accordance with the process of FIG. 4A, detailed above. FIGS. 6B-6H are also referenced in describing the process of FIG. 4B.

The process begins at block 450, where a user activation on a hyperlink is received. This user activation is, for example, an activation by a touch, represented by concentric circles 610 in the FIGS. 6B-6F and 6H, or a conventional “click” from a pointing device, or other cursor activation.

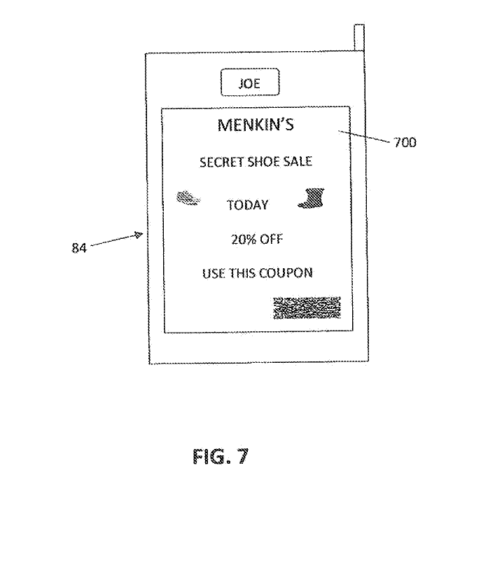

In the ease of a brand being activated, at block 452, it is first determined if the brand is a premium advertiser with the system 30′, at block 454. For example, as shown in FIG. 6B, the brand “Menkins” has been activated. “Menkins” is a premium advertiser, in accordance with their data in the brands subdatabase 103a-1 (FIG. 2B). Accordingly, at block 456, to which the process moves, the system 30′ calls up a template from the application 34a (loaded on the communication device 84), and at block 458 (data for a graphic/image and link (to a target or destination URL) is located in the folder for “Menkins”, for example, in folder database 103d (FIG. 2D), based on the matching Folder ID “XP421CV”, from the Brands Database 103a, for Menkins, subdatabase 103a-1). The folder data is rendered into the template, when necessary with the assistance of the graphics/imaging server 54 (FIG. 1A), with the resultant graphic (or image, or landing graphic) 614 supported by this template, shown in FIG. 6B. The graphic 614 for Menkins, for example, includes three specific shoes 616a-616c, which can be bought now, by activating the “Buy Now” button 618, which is linked to “Menkins” purchasing web site, for example, having the URL www.menkins.com/buyshoes, this web site supported, for example, at server 40a of FIG. 1A. There is also an e-mail box 620, which when activated, a coupon 700 or other electronic graphic of Menkins (FIG. 7) can be sent to and shared with others, including over a social network (server (SN) 50 of FIG. 1A). The process then moves to block 470.

Turning back to block 452, if the brand is not a premium, such as “Addidos”, in Brand subdatabase 103a-2, the process moves to block 459. At block 459, the case of a non-premium advertiser, for example, a default template is called up from the application, and the process moves to block 458, where data, such as a graphic (landing graphic) and a link to the Addidos.com website is created, for placement proximate to the Addidos text block 506. The process moves to block 470. For example, as shown in FIG. 6C, receiving an indication of an activation (touch 630) on the “Addidos” hyperlink 507, results in a graphic 632, with an embedded link to the web site www.addidos.com, hosted, for example, at server 40b (FIG. 1A).

Returning to block 450, if a term, such as “shoes” has been activated, the process moves to block 462. The process moves to block 464, where the system 30′ calls up a template for the number of advertisers (entities) in the inventory, in accordance with rules, in the respective database. If there are not any rules, a default template is called, for example, a default template would at least accommodate an inventory of one advertiser.

For example, in the subdatabase for the term “shoes” 103b-1, there are rules, 1) Display up to four with the addition of up to three more; and 2) Outside inventory is not permissible. Accordingly, there is a chance that advertisers (e.g., inventory), “Addidos” through “Baucony Shoes”, will be used, followed by “Gali Superstore” through “Keds”, all from the database 103b of the system 30′, is applicable. The process moves to block 466, where data for the graphics and links is sent from the corresponding folder, and loaded into the template. The template was called from the application 34a in the communication device, for example, smart phone 84. The process then moves to block 470.

For example, turning to FIG. 6D, for the activated (by the touch 640) hyperlink 503 for “shoes”, a graphic (landing graphic) 642, supporting four graphics 642a-642d have been loaded into the called-up template. The graphics 642a-642d include embedded links to the corresponding web sites. Alternately, turning to FIGS. 6E to 6G, a template capable of displaying a graphic 646, supporting seven graphics with embedded links to their corresponding web sites is shown. Initially, in accordance with the rule, “Display up to four advertisers”, four graphics are shown, for “Addidos” 646a, “Lo-Tech Shoes” 646b, “Feet Locker” 646c, and “Baucony Shoes” 646d. Upon the lower bar 648 being activated, by the touch 650 of FIG. 6F, three additional advertisers (inventory) are displayed, by graphics, “Gali Superstore” 646e, “Puma” 646f, and “Keds” 646g, with embedded links to their corresponding web sites, in accordance with the rule, “with the addition of up to three advertisers if inventory is present” (subdatabase 103b-1). The process then moves to block 470.

Another example is shown in FIG. 6H, for the term “hiking”. The rules are applied, for example from the subdatabase 103b-2, which states, “1) Display up to two advertisers; and, 2) Outside inventory is permissible.” Upon an activation of the “hiking” hyperlink 509, as shown by the touch 660, a template is pulled (block 464). This template from the application 34a supports two graphics, in accordance with the rule, “display up to two”. Accordingly, two graphics, with embedded links, are loaded into the template (block 466), resulting in the graphic 662, with graphics for “Colorado Tourism-Hike in Colorado” 662a and “The Hiker's Blog-Catch the Hiker's Blog” 662b, both from inside the system 30′ (subdatabase 103b-2).

Alternatively, should there have been an inventory of only one advertiser for the term HIKING in subdatabase 103b-2, the system 30′, in accordance with the rules, may go outside for inventory. This may involve using the content server 52 and/or the search engine 106b, to locate and acquire suitable content for the term “hiking”. For example, such content may include that for SNOW HIKES, for a tour operator that conducts hikes in snow, with the URL www.snowhikes.com. This web site would be hosted by a third party server, such as one or more of servers similar to third party servers 40a-40n, and delivered to the system 30′ of the home server 30 via the content server 52 over the Internet 24.

For example, the aforementioned content acquisition and delivery by content server(s) 52 is also in accordance with keyword servers, and the operation of the content servers detailed in U.S. patent application Ser. No. 10/915,975 (U.S. Patent Application Publication No. US 2005/0038861 A1), entitled: Method And System For Dynamically Generating Electronic Communications.

In all of the templates and graphics above, the links (for browser redirection) are mapped back to the system 30′, and accordingly, the home server 30. The browser redirection from the link may go either through the home server 30, or directly to the corresponding web site of the advertiser. In both cases, this mapping back allows for accounting by the accounting module 108a, and analytics, by the analytics module 108b.

At block 470, it is determined in the system 30′ if an activation, such as a touch, or click on the screen of the communication device, for example, smart phone 84, or indication thereof, has been received. If an activation was received at block 470, the process moves to block 472. At block 472, the browser associated with the communication device is redirected to the destination, e.g., web page or web site, or other network location, associated with the embedded link in the activated graphic.

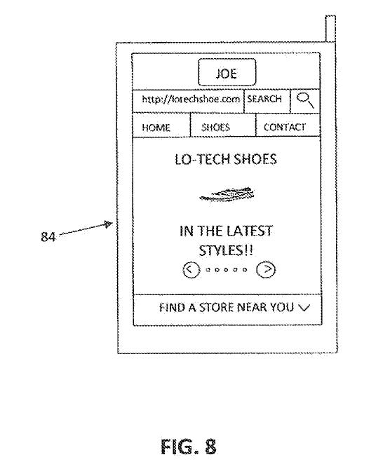

For example, should the “Buy Now” button 618 of the Menkins graphic of FIG. 6B, be activated (touched, clicked or the like), the customer's browser is redirected to a web page of Menkins Department Store (hosted, for example by server 40a), where he can purchase shoes, including those displayed in the graphic. Also, for example, should the graphic for Lo-Tech Shoes 642b in FIG. 6D, be activated (touched, clicked or the like), the customer's browser is redirected to the web site for Lo-Tech Shoes, for example, hosted by server 40d of FIG. 1A. For example, the home page for Lo-Tech Shoes appears on the screen of the customer's smart phone 84, as shown in FIG. 8.

From block 472, the process moves to block 476.

Turning back to block 470, should an activation, or indication thereof, not be received by the system 30′, it is determined if there is a timeout, at block 474. A timeout occurs when the activation or indication thereof is not received in a predetermined time. If there is a timeout, the process returns to block 470. If there is not a timeout, the process moves to block 476.

At block 476, the event, the activation and browser redirection, or alternately, the timeout, is recorded. The recording is in one or more of the accounting 108a and analytics 108b modules, as well as in the customer database 103c and respective subdatabases 103c-1 to 103c-n. This recording occurs due to all graphics and embedded links mapped back to the system 30′ of the home server 30, as detailed above.

From block 476, the process moves to block 478, where it ends.

While embodiments have been shown for the participants in the SMS texting session being customers of the system 20, only one participant of the requisite texting session needs to be a customer of the system 20. Moreover, customers may include temporary customers, those making a single or one-time use of the system 20.

While embodiments have been shown for SMS texting sessions, the disclosed subject matter can be performed with any kind of electronic, cellular, or other data communication texting or text sessions, including over wireless networks (via local area wireless technology, such as WIFI®, or the Institute of Electrical and Electronics Engineers (IEEE) standard 802.11) in accordance with the embodiments described above.

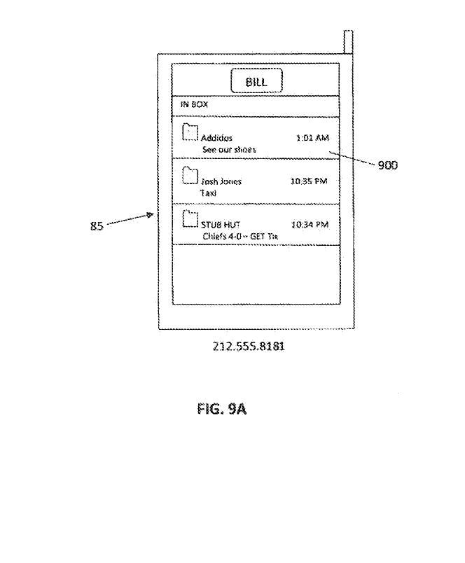

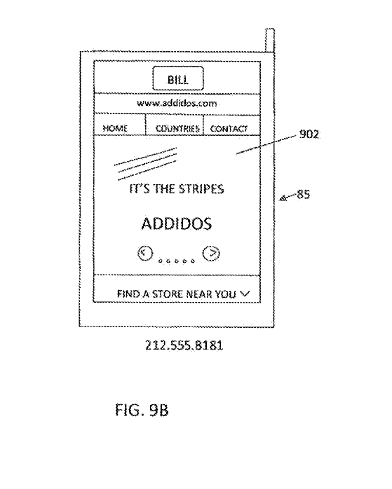

In another embodiment, the analysis engine 106a (FIG. 2A) interacts with the Customer Database 103c of FIG. 2D, and looking at customer Bill 81, he has activated (touched or clicked) on items for the term “shoes” twice. This information can be reported to ADDIDOS and its system administrator 40b′ by the system 30′. Accordingly, in FIG. 9A, the customer's (Bill's 81) communication device 85 has received an e-mail 900 from ADDIDOS, its affiliates, associates, or other related entity, sent to Bill's 81 e-mail address bill@nynet.com corresponding to his smart phone 85. When the e-mail is 900 is opened by an activation (touch or click), for example, by Bill 81, the resultant opened e-mail appears as a graphic 902, corresponding to an ADDIDOS web page (hosted, for example by the server 40b) on the screen of the communication device 85, as shown in FIG. 9B. The customer (e.g., Bill 81) can then interact with the ADDIDOS web page and the ADDIDOS web site (URL of www.addidos.com hosted by the server 40b), via his communication device, e.g., smart phone 85.

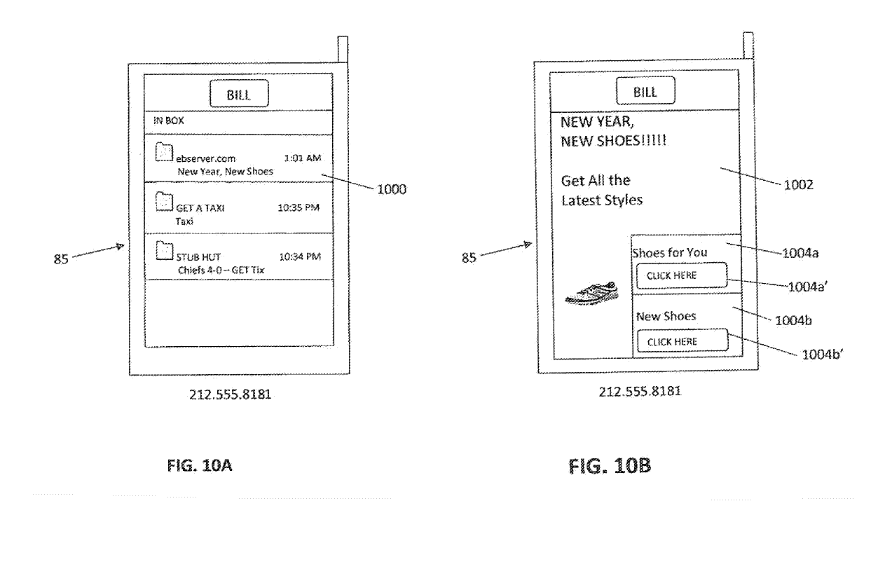

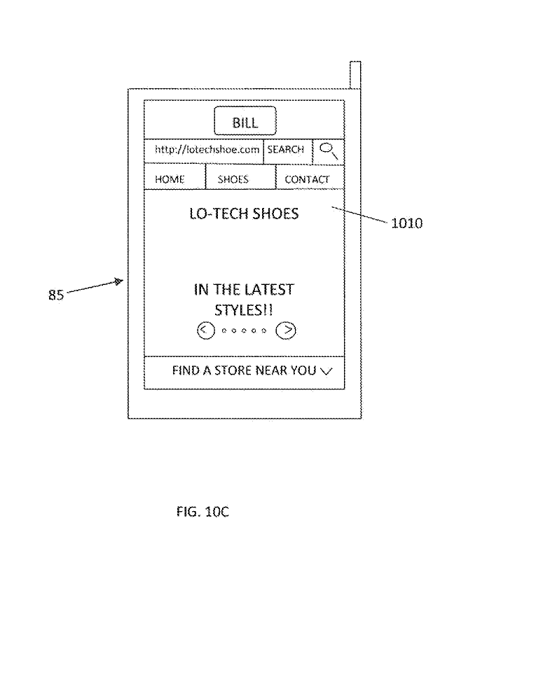

In another embodiment, the analysis engine 106a (FIG. 2A) interacted with the Customer Database 103c of FIG. 2D, and looking at customer Bill 81, he has activated (touched or clicked) on items for the term “shoes” twice. Accordingly, in FIG. 10A, the e-mail/banners server 32 sends the customer's (Bill's 81) communication device 85 an e-mail 1000 for the term “shoes”. Upon opening the e-mail 1000, by an activation (touch or click) a graphic 1002 will appear, in FIG. 10B, with activation or “click” links 1004a (a first position), 1004b (a second position), which, for example, cover embedded links, automatically activated when the corresponding activation or “click” link is activated.

Under activation link 1004a there is be a mapping to a browser redirection to www.addidos.com, typically through the home server 30 (for analytics purposes), since ADDIDOS is the highest ranked. Pay Per Click (PPC) for the term “shoe” in the terms database 103b (FIGS. 2A and 2C). The ranking shown is by PPC amount, with other rankings also permissible. Upon activation of the activation link 1004a, via the “Click Here Button” 1004a′, at this first position, the browser of the communication device 85 is directed to www.addidos.com (hosted by the server 40b), with the graphic/image 902 in accordance with FIG. 9B.

Under activation link 1004b there is a mapping to a browser redirection to the network destination with the URL, www.lotechshoe.com, typically through the home server 30 (for analytics purposes). Lo-Tech Shoes is in the second position (represented by activation link 1004b), as it is the second highest Pay Per Click (PPC) (amount) for the term “shoe” in the terms database 103b (FIGS. 2A and 2C). Upon activation of the activation link 1004b, via the “Click Here Button” 1004b′, the browser (of the communication device 85 of customer Bill 81) is directed to a web page (graphic/image 1010) of the web site www.lotechshoe.com (FIG. 10C), hosted by the server 40d. For example, the aforementioned e-mail, graphics set up, and browser redirection is in accordance with that disclosed in U.S. patent application Ser. No. 10/915,975 (U.S. Patent Application Publication No. US 2005/0038861 A1), entitled: Method And System For Dynamically Generating Electronic Communications, and U.S. patent application Ser. No. 11/774,106 (U.S. Patent Application Publication No. US 2008/0098075 A1), entitled: Method And System For Providing Electronic Communications With Dynamically Provided Content To Third Party Mail Transfer Agents.

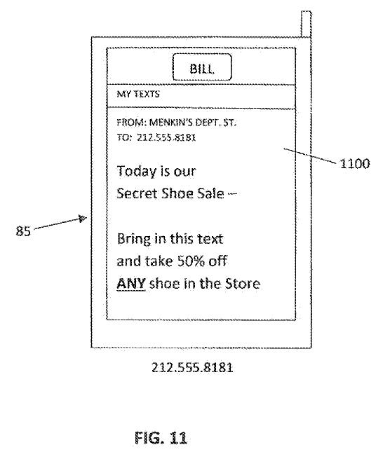

FIG. 11 shows a text message, in a graphic 1100 on the screen of communication device 85 of the customer “Bill” 81 (FIG. 1A). In another embodiment, the analysis engine 106a (FIG. 2A) interacted with the Customers Database 103c of FIG. 2D, and looking at customer Bill 81, he has activated (touched or clicked) on items for the brand “MENKINS”. The system 30′ reported this activation or click information to MENKINS (server 40a), who sent the text (graphic 1100), for example, from their server 40a, to the communication device 85 of customer “Bill” 81 (over the cellular network 60, Internet 24, or combinations thereof). The text of the text message (from Menkins) 1100 indicates a special coupon or offer for this customer.

The e-mail/banners server 32 can also send a banner or other similar graphic based on the PPC model for a Brand or Term of the respective databases 103a, 103b and the respective customer, from the customer database 103c. The analysis engine 106a would select the banner and to the communication device the e-mail/banners server 32 should send it. The banner is, for example, mapped back to the system 30′ and once activated (by a touch or click), the browsing application of the communication device 84, 85 is directed to the destination of the URL associated with the banner. The e-mail/banners server 32 may be configured for sending banners or other similar graphics, for example, in accordance with U.S. patent application Ser. No. 11/256,871, filed on Oct. 24, 2005, entitled: System For Prioritizing Advertiser Communications Over a Network (U.S. Patent Application Publication No. US 2006/0248110 A1), the disclosure of which is incorporated by reference herein in its entirety.

The above-described processes including portions thereof can be performed by software, hardware and combinations thereof. These processes and portions thereof can be performed by computers, computer-type devices, workstations, processors, micro-processors, other electronic searching tools and memory and other non-transitory storage-type devices associated therewith. The processes and portions thereof can also be embodied in programmable non-transitory storage media, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof; herein have been described with exemplary reference to specific hardware and software. The processes (methods) have been described as exemplary, whereby specific steps and their order can be omitted and/or changed, in accordance with the present invention, and including by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

What is claimed is:

1. A method for providing content to a computerized communication device over a network, comprising:
monitoring a texting session occurring over the network for words in the texting session matching predetermined words;
converting at least one selected matching word to a hyperlink; and,
activating a graphic associated with the at least one selected matched word in response to the hyperlink being activated, the activated graphic including an activatable link to a destination over the network from which the content is provided.

2. The method of claim 1, additionally comprising: determining the category of the at least one selected matched word.

3. The method of claim 2, wherein when the at least one selected word is in a first category, the destination includes a web page associated with the at least one selected word.

4. The method of claim 2, wherein when the at least one selected word is in a second category, the destination includes individual web pages, the number of the individual web pages dependent on the number of content providers associated with the at least one selected word.

5. The method of claim 4, wherein the number of content providers associated with the at least one selected word corresponds to the inventory of content providers associated with the predetermined word matching with at least one selected word.

6. The method of claim 5, wherein the inventory of content providers is determined based on the number of content providers and their bids associated with the predetermined word.

7. The method of claim 1, wherein a word is selected from the group consisting of: a single word, multiple words, word fragments, keywords, phrases, identifiers, and combinations thereof.

8. The method of claim 1, wherein the texting session is in Short Message Service (SMS) format.

9. The method of claim 1, wherein the network includes a wireless network and the texting session is conducted over local area wireless technology.

10. A system for providing content to a computerized communication device over a network, comprising:
an analysis engine for monitoring a texting session occurring over the network for words in the texting session matching predetermined words; and,
a processor in communication with the analysis engine, the processor programmed to:
convert at least one selected matching word to a hyperlink; and,
activate a graphic associated with the at least one selected matched word in response to the hyperlink being activated, the activated graphic including an activatable link to a destination over the network from which the content is provided.

11. The system of claim 10, wherein the processor is additionally programmed to determine the category of the at least one selected word, such that the destination includes a web page associated with the at least one selected word.

12. The system of claim 10, wherein the processor is additionally programmed to determine the category of the at least one selected word, such that the destination includes individual web pages, the number of the individual web pages dependent on the number of content providers associated with the at least one selected word.

13. The system of claim 10, wherein the analysis engine analyses Short Message Service (SMS) text.

14. The system of claim 10, wherein the analysis engine analyses text transmitted over local area wireless technology.

15. A computer usable non-transitory storage medium having a computer program embodied thereon for causing a suitable programmed system to provide content to a computerized communication device over a network, by performing the following steps when such program is executed on the system, the steps comprising:
monitoring a texting session occurring over the network for words in the texting session matching predetermined words;
converting at least one selected matching word to a hyperlink; and,
activating a graphic associated with the at least one selected matched word in response to the hyperlink being activated, the activated graphic including an activatable link to a destination over the network from which the content is provided.

16. The computer-usable storage medium of claim 15, wherein the steps additionally comprise:
determining the category of the at least one selected matched word, and, 1) when the at least one selected word is in a first category, the destination includes a web page associated with the at least one selected word, and, 2) when the at least one selected word is in a second category, the destination includes individual web pages, the number of the individual web pages dependent on the number of content providers associated with the at least one selected word.

17. The computer-usable storage medium of claim 16, wherein when the at least one selected word is in the second category, the number of content providers associated with the at least one selected word corresponds to the inventory of content providers associated with the predetermined word matching with at least one selected word.

18. The computer-usable storage medium of claim 17, wherein the inventory of content providers is determined based on the number of content providers and their bids associated with the predetermined word.

19. The computer-usable storage medium of claim 15, wherein a word is selected from the group consisting of: a single word, multiple words, word fragments, keywords, phrases, identifiers, and combinations thereof.

20. The computer-usable storage medium of claim 15, wherein the texting session is selected from the group consisting of Short Message Service (SMS) format or in a format supported by local area wireless technology.
